(19) United States
(12) Patent Application Publication
(10) Pub. No.: US 2020/0337423 A1
(43) Pub. Date: Oct. 29, 2020

(54) Inner shine

(71) Applicant: Joseph Atias, Great Neck, NY (US)

(72) Inventor: Joseph Atias, Great Neck, NY (US)

(21) Appl. No.: 16/392,389

(22) Filed: Apr. 23, 2019

(51) Int. Cl. A44C 15/00; F21V 33/00; F21V 8/00; G02B 6/26

(52) U.S. Cl. CPC A44C 15/0015; F21V 33/0004; A44C 17/02; G02B 6/262; G02B 6/0008

(57) ABSTRACT

An article of jewelry arranged to enhance natural optical effects, such as sparkle and scintillation, is described. The article comprises a gem, such as a brilliant cut diamond, and one or more light sources. A device is Incorporated in the article of jewelry for the purpose of amplifying the light so as to enhance the appearance of the gemstone. This is accomplished by channeling ambient light through, for example, an optical fiber into the gemstone. The ambient light is amplified using a lens in order to make the gem appear more brilliant which drives additional light into the gem to enhance the natural optical effects of the gem.

### BACKGROUND OF THE INVENTION

The present invention concerns improvements relating to jewelry and the appearance of gemstones. A gemstone is an optical system that is manufactured from a material that is not opaque to light. It may be a natural mineral or a manufactured artificial mineral or optical compound. The design is such that when illuminated and viewed from the front the light falling upon it is largely refracted, internally reflected and returned to the front so that the gemstone appears bright. The refraction and reflection process may also change the color of the light emitted after passing through the gemstone and reemerging.

The process of design and manufacture of a gemstone often involves cutting the mineral into carefully designed angles and facets that are intended to achieve the desired optical effects of causing the front surface to sparkle or scintillate as the refraction and reflection occur. Such optical effects occur when the jewel stones catch external ambient light. Cut gemstones may be made from a wide variety of materials, for example, diamonds or cubic zirconium which is a material approaching the hardness of a diamond and often used as an artificial replacement.

Although gemstones are generally designed to have an optical effect, when external light is not strong, little optical effect including scintillation effect occurs and the colors of the jewel stones are not readily visible. By increasing the light, or by channeling additional ambient light to the gem, the gem appears more brilliant than under normal ambient light.

Artificial illumination of a gem in an article of jewelry has previously been described in GB 1 352 835, where a translucent gem can be illuminated intermittently by battery-powered light-emitting diodes provided on the non-viewing side of the article. The LED's can be pulsed by signals from a control circuit which are generated by sensing the wearer's movement, or external sound or light.

Another artificially Illuminated article of jewelry is described in U.S. Pat. No. 4,973,835 where an LED is provided near a transparent body Uewel). The light emitter comprises frequency pulse generators and a light detector. When the signal processor receives a low-light signal, the light detector signal being sampled at the frequency of one of the pulse generators, the processor controls the light-emission timing to cause the light emitter to emit light at the frequency of the other frequency generator. Otherwise, the light emitter is not driven and the jewel is not illuminated by the light emitter.

In the prior art, the gem illumination is at best rather crude in both GB 1 352 835 and U.S. Pat. No. 4,973,835, the pulsing of the LEDs being entirely dependent on external conditions such that the illumination lacks consistency. During periods of time when the sensed light does not change, the illumination is inactive. For example, in GB 1 352 835 when a motion sensing device is employed and the user is stationary, light pulses are not generated. Also, in the device of U.S. Pat. No. 4,973,835 light pulses are not generated in bright light conditions. Furthermore, in low-light conditions, the U.S. Pat. No. 4,973,835 device can only produce a consistently repeating pattern of light pulses at a regular frequency from which it is apparent that there is artificial lighting of the jewel. As digital pulses are used in both of the above described prior art arrangements to drive the LEDs, the duration and the intensities of the light pulses emitted from each LED are constant. The esultant light output does not mimic the natural illumination of the jewel. In U.S. Pat. No. 6,433,483, LEDs are also used, detracting from the natural effect.

All of the above features of the prior art devices make the artificial illumination of the jewel readily distinguishable from natural light illumination of a jewel. More particularly, the prior art devices produce illumination light pulses which are either too regular or too irregular to be of effective use in simulating natural optical effects such as sparkle or scintillation of the jewel. The device of this invention amplifies the natural or ambient light by channeling additional light into the gem, thereby creating a totally natural effect. The resulting effect makes the gem appear more brilliant and appear of better quality.

### SUMMARY OF THE INVENTION

An object of the present invention is to provide an article of jewelry in which the gem is naturally illuminated in such a way as to enhance its appearance. This is accomplished by channeling additional ambient light into the gem so as to make the gem appear more brilliant and of higher quality.

Thus, an article of jewelry embodying the present invention can maintain an enhanced appearance in the presence of ambient light. The stimulation of the optical effects enhances the natural optical effects of the gem.

The term “jewel” is to be construed broadly throughout this description to mean any article or a material having optical reflective and/or refractive properties. Examples of such jewels are one or more precious stones such as diamonds or rubies, semiprecious stones, and imitations of such stones made from artificial materials. These jewels may be combined aesthetically as desired. The amplification of light in this way enhances the natural internal optical reflections of a gemstone. The light reaching the viewer appears to come from different positions within the gem in the preferred embodiment which represents a realistic optical effect. The channeling of ambient light using, for example, fiber optics and lenses, to increase the ambient light entering the gem causes the gem to appear more brilliant and of higher quality.

A jewel may be coupled to more than one or more redirecting light sources. In one embodiment of the present invention, the light sources are arranged to channel ambient light of different colors through lenses. This advantageously provides stimulation of the natural refractive optical effects that are seen in an externally illuminated gem. Advantageously, realistic visual effects can be produced by varying the color of the gem.

### DETAILED DESCRIPTION OF THE PREFERRED EMBODIMENTS

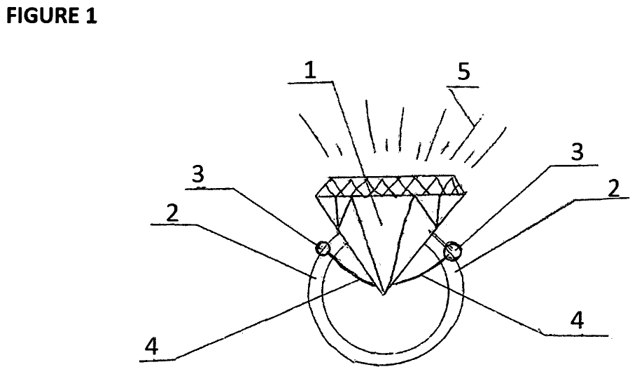

Referring to FIG. 1, there is shown a first presently preferred embodiment of the invention. FIG. 1 shows an illumination system used in an item of jewelry namely, ring 2. Other geometrical configurations of the system are possible as is the use of the system in other types of jewelry. Beside each gemstone are one or more lenses 3. Each lens 3 is attached to a fiber optic 4 which is used to channel light collected by lens 3 into the gemstone 1 which is embedded within and around ring 2. The result is the redirecting of ambient light into the gemstone creating a more brilliant optical effect 5 in the gemstone 1.

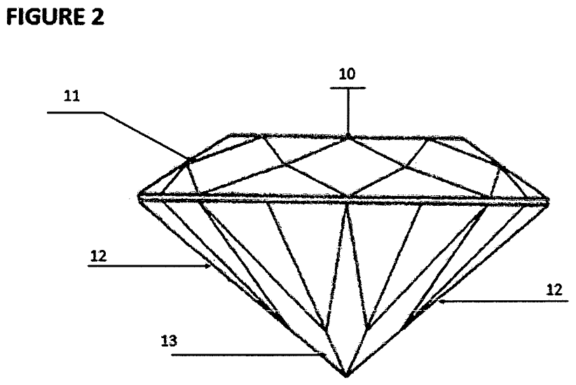

FIG. 2 shows one embodiment of a geometric form of a gemstone having facets such as shown at 11, 12, and 13 to reflect and refract the ambient light entering the gemstone back to the table 10 of the gemstone.

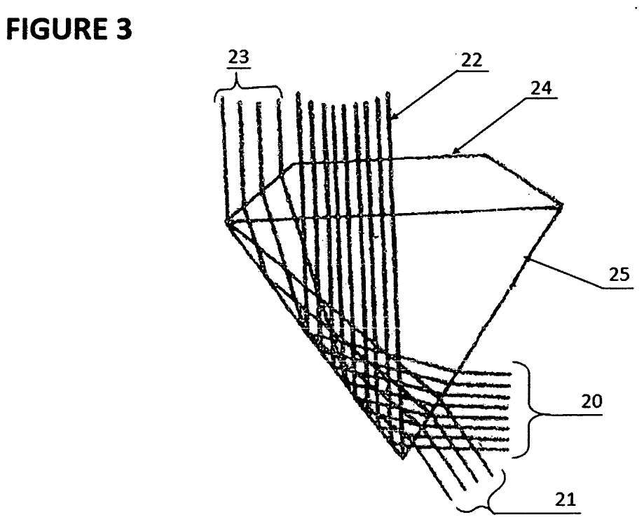

FIG. 3 shows the reflectivity of the ambient light entering the gemstone at 20 and 21 and leaving the gemstone at 22 and 23, which makes the gemstone appear more brilliant through table 24 of the gemstone.

1. An article of jewelry containing a gemstone arranged to enhance optical effects, such as sparkle, the article comprising a gem and at least one diverting light source incorporated in the article of jewelry for enhancing the optical effect of the gem.

2. An article of jewelry according to claim 1, wherein the light output intensity is increased causing the gem to appear more brilliant and of better quality.

3. An article of jewelry according to claim 1, wherein the gem is enhanced by an optical light source, such as a fiber optic so as to cause the ambient light to be amplified.

4. An article of jewelry according to claim 1, further comprising: one or more additional light sources, each being arranged to illuminate the gem and equipped with a lens to channel additional light to the gem.

5. An article of jewelry according to claim 4, wherein the lens or lenses are colored to make the gem have an appearance of a different color.

6. An article of jewelry according to claim 1, wherein the jewel includes at least one precious stone, semi-precious stone or imitation stone. [symbol]
